(19) United States
(12) Patent Application Publication
(10) Pub. No.: US 2014/0313407 A1
(43) Pub. Date: Oct. 23, 2014

(54) PROTECTIVE COVER

(71) Applicants: Cheng-Yen Chen, Tainan City (TW); Pei-Hsin Chen, Tainan City (TW); Yi-Chun Shih, Tainan City (TW)

(72) Inventors: Cheng-Yen Chen, Tainan City (TW); Pei-Hsin Chen, Tainan City (TW); Yi-Chun Shih, Tainan City (TW)

(73) Assignee: GENESIS PHOTONICS INC., Tainan City (TW)

(21) Appl. No.: 14/010,560

(22) Filed: Aug. 27, 2013

(30) Foreign Application Priority Data
Apr. 23, 2013 (TW) 102114389

(51) Int. Cl. H04N 5/225

(52) U.S. Cl. CPC H04N 5/2252
USPC 348/376

(57) ABSTRACT

A protective cover is detachably assembled to and electrically connected to an electronic device having an image capturing unit and a lens. The protective cover includes a base portion, at least one bending portion, and a plurality of light-emitting units. The electronic device is disposed on the base portion. The bending portion is foldably connected to at least one side of the base portion. There is at least one included angle between a side of the electronic device and the bending portion. The light-emitting units are disposed on the bending portion, and the light-emitting units are not coplanar with the lens.

### CROSS-REFERENCE TO RELATED APPLICATION

This application claims the priority benefit of Taiwan application serial no. 102114389, filed on Apr. 23, 2013. The entirety of the above-mentioned patent application is hereby incorporated by reference herein and made a part of this specification.

### FIELD OF THE INVENTION

This invention relates to a protective cover, and more particularly, to a protective cover which is detachably assembled to an electronic device.

### DESCRIPTION OF RELATED ART

With the rapid development of technology, the portable electronic devices, such as tablet PCs, smart phones, and so on, have been widely adopted by users due to the advantages of portability and simple operation. Nevertheless, the portable electronic devices may be easily bumped, which causes damages to the portable electronic devices or the covers thereof. Therefore, to avoid said situations, there are various types of protective covers available in the market.

Additionally, in order to meet users' needs of the portable electronic devices, the portable electronic devices also have built-in cameras to provide a function of instant image capturing. Generally, a camera lens and a flash light of the portable electronic device are located on the same plane and are arranged at a short distance from each other, which saves the circuit layout space. Besides, the design of the flash light also provides a light compensation function to allow the users to take pictures in low-light or back-lighting situations. Nevertheless, the configuration of the flash light and the camera lens creates a narrow light-emitting angle which leads to direct and excessively concentrated lighting and easily results in casting a shadow behind the subject to be shot; alternatively, the subject to be shot may have an over-stiff outline or encounter an issue of unsightly reflecting light. Hence, the users may manually operate a diffusion sheet or a reflective sheet to allow the flash light to be more evenly projected on the subject. However, the diffusion sheet or the reflective sheet usually requires manual installation and removal, which is quite inconvenient to the users.

### SUMMARY OF THE INVENTION

This invention provides a protective cover that is multi-functional and easy to use.

The invention provides a protective cover which is detachably assembled to and electrically connected to an electronic device having an image capturing unit and a lens corresponding to the image capturing unit. The protective cover includes a base portion, at least one bending portion, and a plurality of light-emitting units. The electronic device is disposed on the base portion. The bending portion is foldably connected to at least one side of the base portion, and the bending portion and a side of the electronic device define at least one included angle. The light-emitting units are disposed on the bending portion, and the light-emitting units and the lens are not co-planar.

In an embodiment of the invention, the bending portion has at least one reflecting region which surrounds the light-emitting units.

In an embodiment of the invention, the bending portion has at least one reflecting region which is formed by attaching a reflective sheet to the bending portion or coating the bending portion with a reflective layer.

In an embodiment of the invention, the included angle is less than or substantially equal to 90 degrees.

In an embodiment of the invention, the light-emitting units are a plurality of light-emitting diodes, a plurality of the xenon lamps or a combination of the above.

In an embodiment of the invention, the light-emitting diodes are a combination of light-emitting diodes with different colors.

In an embodiment of the invention, the light-emitting units are arranged along one horizontal axis, arranged along one vertical axis, or circularly arranged with respect to one center point.

In an embodiment of the invention, the at least one bending portion is defined as two bending portions. The bending portions are foldably and respectively connected to two opposite sides of the base portion. The bending portions and the two sides of the electronic device define a first included angle and a second included angle, where the first included angle and the second included angle are less than or substantially equal to 90 degrees.

In an embodiment of the invention, the at least one bending portion is defined as three bending portions. The bending portions are foldably and respectively connected to three sides of the base portion. The bending portions and the three sides of the electronic device define a first included angle, a second included angle, and a third included angle, where the first included angle, the second included angle, and third included angle are less than or substantially equal to 90 degrees.

In an embodiment of the invention, the protective cover further includes at least one covering portion which is connected to at least one side of the base portion and covers at least one side of the electronic device, and the covering portion is perpendicular to the base portion. Besides, a surface area of the covering portion is equal to a side surface area of the side of electronic device, and the light-emitting units are disposed on the covering portion.

In an embodiment of the invention, the electronic device includes a personal digital assistant, a mobile phone, a tablet computer, a notebook computer, or a satellite navigation device.

In an embodiment of the invention, the protective cover is electrically connected to the electronic device through a wired transmission or a wireless transmission.

Based on the above, the protective cover is detachably assembled to an electronic device, and the protective cover has the bending portion which is foldably connected to the base portion. Here, the light-emitting units are disposed on the bending portion, and the light-emitting units and the lens are not co-planar. Therefore, the protective cover can apply the bending portion to protect the exterior of the electronic device, the non co-planar design of the light-emitting units and the lens also allows the light-emitting units to provide the electronic device with sufficient brightness and wide light-emitting angle for light compensation when the electronic device performs a photo-taking function. In brief, the protective cover described herein is multi-functional and easy to use.

To make the above features and advantages of this invention more comprehensible, several embodiments accompanied with drawings are described in detail as follows.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a schematic view illustrating a protective cover and an electronic device according to an embodiment of this invention.

FIG. 2 is a schematic view illustrating a protective cover and an electronic device according to another embodiment of this invention.

FIG. 3 is a schematic view illustrating a protective cover and an electronic device according to another embodiment of this invention.

FIG. 4 is a schematic view illustrating a protective cover and an electronic device according to another embodiment of this invention.

FIG. 5 is a schematic view illustrating a protective cover and an electronic device according to another embodiment of this invention.

### DESCRIPTION OF THE EMBODIMENTS

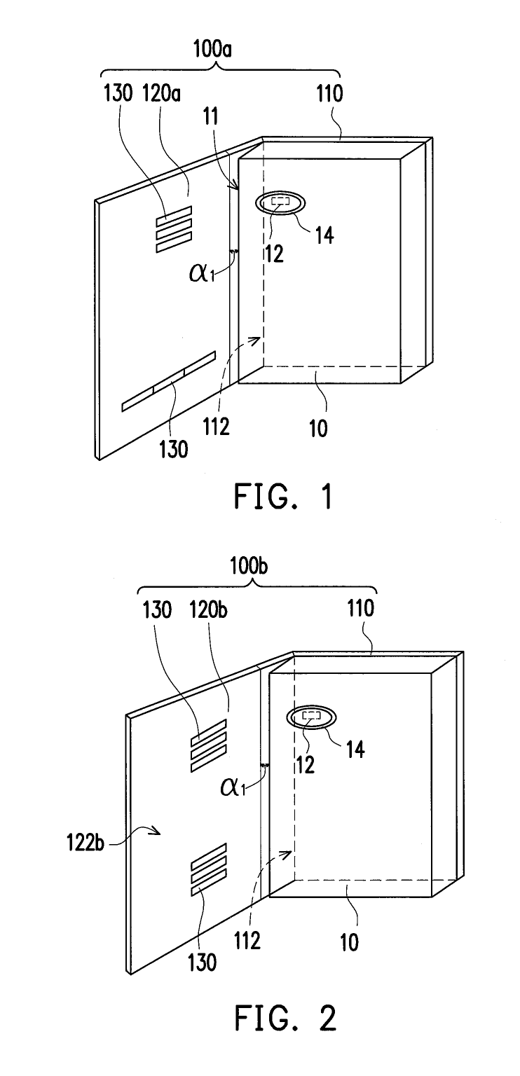

FIG. 1 is a schematic view illustrating a protective cover and an electronic device according to an embodiment of this invention. With reference to FIG. 1, in this embodiment, the protective cover 100a is detachably assembled to an electronic device 10, and the electronic device 10 is electrically connected to the protective cover 100a. The electronic device 10 has an image capturing unit 12 and a lens 14 which corresponds to the image capturing unit 12. In this embodiment, the electronic device 10 includes a personal digital assistant (PDA), a mobile phone, a tablet computer, a notebook computer, or a satellite navigation device, which however should not be construed as a limitation to the invention.

In detail, the protective cover 100a in this embodiment includes a base portion 110, at lease one bending portion 120a (only one bending portion is schematically illustrated in FIG. 1), and a plurality of light-emitting units 130. The electronic device 10 is disposed on the base portion 110. The bending portion 120a is foldably connected to a side 112 of the base portion 110, and a side 11 of the electronic device 10 and the bending portion 120a define a first included angle, which is illustrated as al in FIG. 1. The light-emitting units 130 are disposed on the bending portion 120a, wherein the light-emitting units 130 and the lens 14 are not co-planar.

More specifically, the protective cover 100a in this embodiment is electrically connected to the electronic device 10, for example, by a cable transmission, e.g., a universal serial bus, or a wireless transmission, e.g., Bluetooth. The first included angle α1 between the electronic device 10 and the bending portion 120a is preferred to be less than or substantially equal 90 degrees. If the first included angle α1 is greater than 90 degrees, the light from the light-emitting units 130 may be too divergent to render favorable light compensation effects. Here, the surface area of the bending portion 120a is greater than the side surface area of the side 11 of the electronic device 10, and the bending portion 120a can be folded to cover the electronic device 10 and can play a role in protecting the exterior of the electronic device 10. The light-emitting units 130 are, for instance, a plurality of light-emitting diodes, a plurality of the xenon lamps, or a combination of the above. Here, as an example, the light-emitting diodes are the light-emitting units 130, wherein the light-emitting diodes are a combination of light-emitting diodes with different colors, e.g., a combination of red light-emitting diodes, blue light-emitting diodes, and green light-emitting diodes; the invention does not pose any limitation thereto.

In more detail, as shown in FIG. 1, the light-emitting units 130 in this embodiment can be arranged along the same vertical axis, such as, the light-emitting units 130 arranged on top of the bending portion 120a. Alternatively, the light-emitting units 130 can be arranged along the same horizontal axis, such as, the light-emitting units 130 arranged on the bottom of the bending portion 120a. In other embodiments that are not illustrated, the light-emitting units may be circularly arranged with respect to the same center point and should not be limited to those described herein.

In this embodiment, the protective cover 100a is detachably assembled to the electronic device 10; therefore, the protective cover 100a in this embodiment is easy to use for the users. Furthermore, the bending portion 120a of the protective cover 100a in this embodiment is foldably connected to the base portion 110, and after use, the bending portion 120a can be folded and accommodated on the top of the electronic device 10, so as to perform the function of protecting the image capturing unit 12 and the lens 14. Moreover, because of the light-emitting units 130 disposed on the bending portion 120a, the users can adjust the light compensation angle of the light-emitting units 130 by changing the first included angle α1 between the bending portion 120a and the electronic device 10, which allows the electronic device 10 to achieve favorable photographing effects. In addition, since the light-emitting units 130 in this embodiment are made of light-emitting diode chips which are capable of better ability to compensate light and control white balance. On the other hand, a xenon lamp may be further applied to improve the brightness and the light compensation effect. In addition to the above, people having ordinary skill in the art should be able to make other proper modifications based on actual conditions.

It should be noted that the reference numerals and parts of the contents in the previous embodiment are used in the following embodiments, in which identical reference numerals indicate identical or similar components, and repetitive descriptions of the same technical contents are omitted. For detailed descriptions of the omitted parts, references can be found in the previous embodiments, and thus no repetitive description is provided in the following embodiments.

FIG. 2 is a schematic view illustrating a protective cover and an electronic device according to another embodiment of this invention. Please refer to FIG. 2, the protective cover 100b in this embodiment is similar to the protective cover 100a in FIG. 1, and one of the differences is that the bending portion 120b in this embodiment has a reflecting region 122b surrounding the light-emitting units 130, and the reflecting region 122b is formed, for example, by attaching a reflective sheet to the bending portion 120b or coating the bending portion 120b with a reflective layer. As the bending portion 120b in this embodiment has the reflecting region 122b which can more efficiently reflect the light emitted from the light-emitting units 130 and compensate the light for the subject to be shot, the electronic device 10 can obtain the scattered light through applying this method and employ the scattered effect to vividly demonstrate the somatosensory texture of the subject to be shot and create a sense of space.

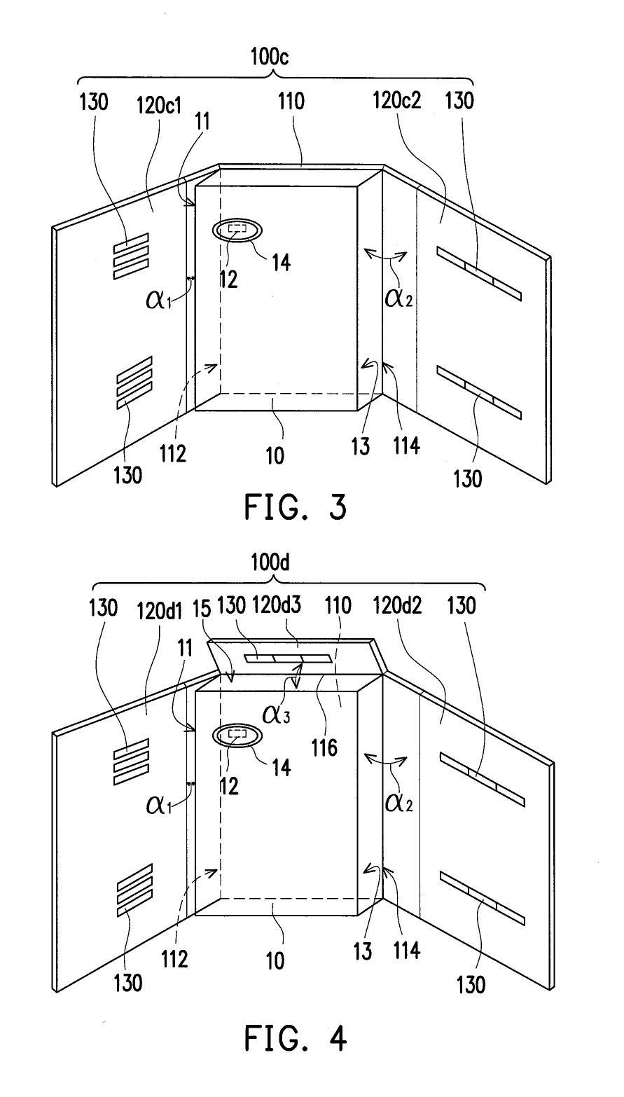

FIG. 3 is a schematic view illustrating a protective cover and an electronic device according to another embodiment of this invention. Please refer to FIG. 3, the protective cover 100c in this embodiment and the protective cover 100a in FIG. 1 are similar, and one of the differences is that the bending portions in this embodiment are two bending portions 120c1 and 120c2. The bending portions 120c1 and 120c2 are foldably connected to the two opposite sides 112 and 114 of the base portion 110. The surface area of each bending portion 120c1 (or each bending portion 120c2) is greater than the side surface area of the side 11 (or a side 13) of the electronic device 10, so as to cover and protect the exterior of electronic device 10. In particular, the bending portions 120c1 and 120c2 and the two sides 11 and 13 of the electronic device 10 define a first included angle α1 and a second included angle α2. Preferably, each of the first included angle α1 and the included second angle α2 is less than or substantially equal to 90 degrees.

The protective cover 100c in this embodiment has two bending portions 120c1 and 120c2 that are symmetrically arranged, which ensures a wide light-emitting angle in the horizontal direction. Therefore, the users can adjust the light compensation angle of the light-emitting units 130 by changing the first included angle α1 and the second included angle α2 between the bending portions 120c1 and 120c2, and the electronic device 10 may accordingly create favorable photographing effects through light compensation.

FIG. 4 is a schematic view illustrating a protective cover and an electronic device according to another embodiment of this invention. Please refer to FIG. 4, the protective cover 100d in this embodiment and the protective cover 100a in FIG. 1 are similar, and one of the differences is that the bending portions in this embodiment are three bending portions 120d1, 120d2, and 120d3, where the bending portions 120d1, 120d2, and 120d3 are foldably connected to three sides 112, 114, and 116 of the base portion 110 separately. The surface area of each of the bending portions 120d1, 120d2, and 120d3 is greater than the side surface area of the side 11 (or the side 13 or the side 15) of the electronic device 10. The bending portions 120d1, 120d2, and 120d3 and the three sides 11, 13, and 15 of the electronic device 10 define a first included angle α1, a second included angle α2, and a third included angle α3. Preferably, the first included angle α1, the second included angle α2 and the third included angle α3 are less than or substantially equal to 90 degrees.

The protective cover 100d in this embodiment has three bending portions 120d1, 120d2, and 120d3, which ensures a wide light-emitting angle in the horizontal and vertical directions. Therefore, the users can adjust the light compensation angle of the light-emitting units 130 by changing the first included angle α1, the second included angle α2, and the third included angle α3, which are respectively between the bending portions 120d1, 120d2, and 120d3 and the electronic device 10. This allows the electronic device 10 to achieve favorable photographing effects through light compensation.

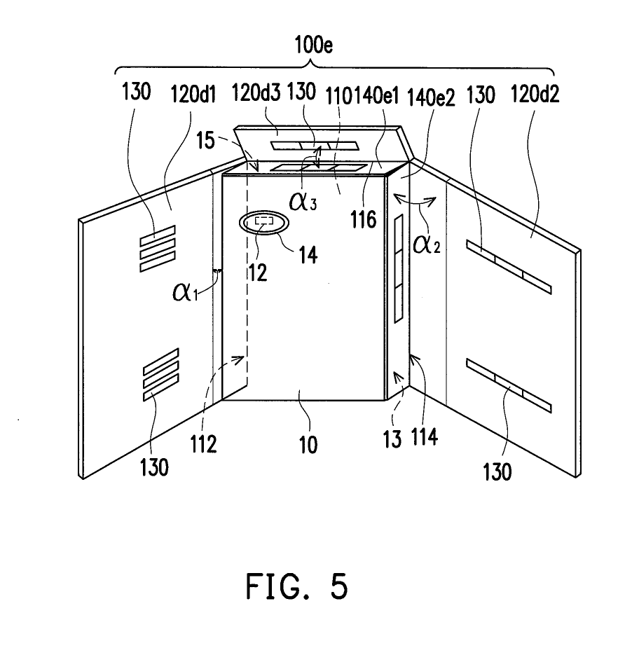

FIG. 5 is a schematic view illustrating a protective cover and an electronic device according to another embodiment of this invention. Please refer to FIG. 5, the protective cover 100e in this embodiment and the protective cover 100a in FIG. 1 are similar, and one of the differences is that the protective cover 100e in this embodiment further includes at least one covering portion (FIG. 5 schematically illustrates two covering portions 140e1 and 140e2). The covering portions 140e1 and 140e2 are connected to the sides 116 and 114 of the base portion 110 and cover the sides 15 and 13 of the electronic device 10, wherein the covering portions 140e1 and 140e2 are perpendicular to the base portion 110. Besides, the surface area of each of the covering portions 140e1 and 140e2 is equal to the side surface area of each side 15 and 13 of the electronic device 10. The light-emitting units 130 are disposed on the covering portions 140e1 and 140e2 and the bending portions 120d1, 120d2, and 120d3. In other embodiments which are not illustrated, the covering portions may be disposed on any side of the electronic device 10 without being limited to what is described herein.

As the protective cover 100e in this embodiment has three bending portions 120d1, 120d2, and 120d3, the users can adjust the light compensation angles of the light-emitting units 130 by changing the included angles which are between the bending portions, 120d1, 120d2, and 120d3 and the electronic device 10. This allows the electronic device 10 to have favorable photographing effects through light compensation. Additionally, the protective cover 100e in this embodiment also includes the covering portions 140e1 and 140e2 that perform an auxiliary function of adjusting the light compensation angle for the light-emitting units 130.

In addition, the design of the bending portion 120b having a reflecting region 122b or the design of the covering portions 140e1 and 140e2, as mentioned above, can be adopted in other embodiments which are not illustrated yet. According to the above descriptions in the previous embodiments, people having ordinary skill in the art can use the aforementioned components to achieve the desired technical effects based on the actual requirements.

In conclusion of the above, the protective cover is detachably assembled to an electronic device, and the bending portion is foldably connected to the base portion. Here, the light-emitting units and are disposed on the bending portion, and the light-emitting units and the lens are not co-planar. Thus, the bending portion of the protective cover not only protects the exterior of the electronic device but also adjusts the light compensation angle through the changes to the included angle between the bending portions and electronic device, which ensures the electronic device to achieve favorable photographing effects. Furthermore, the non co-planar design of the light-emitting units and the lens allows the light-emitting units to provide the electronic device with sufficient brightness and wide light-emitting angle when the electronic device performs a photo-taking function. In addition, the reflecting region of the bending portion of the light-emitting units can achieve light compensation for the subject to be shot because of the reflecting or scattering phenomena. To sum up, the protective cover described herein is multi-functional and easy to use.

Although the this invention has been described with reference to the above embodiments, it will be apparent to one of the ordinary skill in the art that modifications to the described embodiments may be made without departing from the spirit of the invention. Accordingly, the scope of the invention is defined by the attached claims not by the above detailed descriptions.

What is claimed is:

1. A protective cover detachably assembled to an electronic device, wherein the electronic device is electrically connected to the protective cover and has an image capturing unit and a lens corresponding to the image capturing unit, the protective cover comprising:
a base portion, the electronic device being disposed on the base portion;
at least one bending portion foldably connected to at least one side of the base portion, wherein the at least one bending portion and a side of the electronic device define at least one included angle; and
a plurality of light-emitting units disposed on the at least one bending portion, wherein the light-emitting units and the lens are not co-planar.

2. The protective cover as claimed in claim 1, wherein the at least one bending portion has at least one reflecting region surrounding the light-emitting units.

3. The protective cover as claimed in claim 2, wherein the at least one reflecting region is formed by attaching a reflective sheet to the at least one bending portion or coating the at least one bending portion with a reflective layer.

4. The protective cover as claimed in claim 1, wherein the included angle is less than or substantially equal to 90 degrees.

5. The protective cover as claimed in claim 1, wherein the light-emitting units are a plurality of light-emitting diodes, a plurality of xenon lamps, or a combination of the above.

6. The protective cover as claimed in claim 5, wherein the light-emitting diodes are a combination of light-emitting diodes with different colors.

7. The protective cover as claimed in claim 1, wherein the light-emitting units are arranged along one horizontal axis, arranged along one vertical axis, or circularly arranged with respect to one center point.

8. The protective cover as claimed in claim 1, wherein the at least one bending portion is defined as two bending portions foldably connected to two opposite sides of the base portion, respectively, the bending portions and the two sides of the electronic device define a first included angle and a second included angle, and the first included angle and the second included angle are less than or substantially equal to 90 degrees.

9. The protective cover as claimed in claim 1, wherein the at least one bending portion is defined as three bending portions foldably connected to three sides of the base portion, respectively, the bending portions and the three sides of the electronic device define a first included angle, a second included angle, and a third included angle, and the first included angle, the second included angle, and third included angle are less than or substantially equal to 90 degrees.

10. The protective cover as claimed in claim 1, further comprising:
at least one covering portion connected to the at least one side of the base portion and covering at least one side of the electronic device, wherein the least one covering portion is perpendicular to the base portion, a surface area of the at least one covering portion is equal to a side surface area of the side of the electronic device, and the light-emitting units are disposed on the at least one covering portion.

11. The protective cover as claimed in claim 1, wherein the electronic device comprises a personal digital assistant, a mobile phone, a tablet computer, a notebook computer, or a satellite navigation device.

12. The protective cover as claimed in claim 1, wherein the protective cover is electrically connected to the electronic device through a wired transmission or a wireless transmission.
